(19) United States
(12) Patent Application Publication
(10) Pub. No.: US 2012/0057254 A1
(43) Pub. Date: Mar. 8, 2012

(54) HIGH STABILITY REFLECTIVE ELEMENT MOUNT

(75) Inventors: David F. Arnone, Mountain View, CA (US); Ken Wallace, Campbell, CA (US); Michael Pushkarsky, San Diego, CA (US); Jason Sensibaugh, San Diego, CA (US); Bradley Charles Steele, San Diego, CA (US); Brian Jacob Long, San Diego, CA (US); Mark R. Lewis, Oceanside, CA (US); Gregory Hunt Gates, Golden, CO (US)

(73) Assignee: Daylight Solutions, Inc., San Diego, CA (US)

(21) Appl. No.: 13/221,721

(22) Filed: Aug. 30, 2011

Related U.S. Application Data
(60) Provisional application No. 61/378,727, filed on Aug. 31, 2010.

(51) Int. Cl. G02B 7/182

(52) U.S. Cl. 359/872

(57) ABSTRACT

A beam director (360) for directing a beam (356, 358) comprises a director base (464), a reflective element (462), a base pivot (474A), an element pivot (470), and a first element fastener (468A). The director base (464) is positioned adjacent to a mounting base (226). A first interface between the director base (464) and the mounting base (226) is in a first interface plane that is orthogonal to a first axis. The base pivot (474A) provides a base pivot axis for selectively rotating the director base (464) and the reflective element (462) relative to the mounting base (226) about the first axis. The element pivot (470) guides the rotation of the reflective element (462) relative to the director base (464) about a second axis that is orthogonal to the first axis. The first element fastener (468A) is selectively movable between a locked position and an unlocked position to selectively inhibit rotation of the reflective element (462) relative to the director base (464) about the second axis. Additionally, the first element fastener (468A) moves along an axis that is orthogonal to the second axis during movement between the unlocked position and the locked position.

### RELATED INVENTION

This application claims priority on U.S. Provisional Application Ser. No. 61/378,727, filed Aug. 31, 2010 and entitled “HIGH STABILITY MIRROR MOUNT”. As far as permitted, the contents of U.S. Provisional Application Ser. No. 61/378,727 are incorporated herein by reference.

### BACKGROUND

Anti-aircraft missiles can be used to attack and destroy target aircraft, while not requiring the attackers to get too close to the intended target. Moreover, anti-aircraft missiles typically include a guidance system that enables the anti-aircraft missile to become locked onto the target aircraft despite attempted evasive maneuvers by the target aircraft. Thus, the party being attacked needs to develop means by which they can evade and/or disable the anti-aircraft missiles. One means for disabling the anti-aircraft missiles is to develop reliable and cost-effective means to jam or otherwise disable the guidance system of the anti-aircraft missile. For example, the party being attacked can utilize a precisely generated and directed laser beam to jam or otherwise disable the guidance system of the anti-aircraft missile.

### SUMMARY

The present invention is directed toward a beam director for directing a beam, the beam director being secured to a mounting base. In certain embodiments, the beam director comprises a director base, a reflective element, a base pivot, an element pivot, and a first element fastener. The director base is positioned adjacent to the mounting base. A first interface between the director base and the mounting base is in a first interface plane that is orthogonal to a first axis. The reflective element has a reflective surface. The base pivot provides a base pivot axis for selectively rotating the director base and the reflective element relative to the mounting base about the first axis. The element pivot guides the rotation of the reflective element relative to the director base about a second axis that is orthogonal to the first axis. The first element fastener is selectively movable between a locked position and an unlocked position to selectively inhibit rotation of the reflective element relative to the director base about the second axis. Additionally, the first element fastener moves along an axis that is orthogonal to the second axis during movement between the unlocked position and the locked position.

In one embodiment, the reflective surface is integral to the reflective element. Additionally, in one embodiment, the director base, the reflective element and the mounting base are each made of the same material.

In some embodiments, the beam director further comprises an adjuster that selectively adjusts the position of the reflective element relative to the director base about the second axis. In one such embodiment, the adjuster is threaded into and through the reflective element so that a distal tip of the adjuster selectively engages the director base.

Additionally, in one embodiment, the reflective element is positioned adjacent to the director base. In such embodiment, a second interface between the reflective element and the director base is in a second interface plane that is orthogonal to the second axis.

In certain embodiments, the beam director further comprises a base fastener that selectively clamps the director base to inhibit rotation of the director base and the reflective element relative to the mounting base about the first axis.

In one embodiment, the first element fastener extends through the director base and is threaded into the reflective element. Additionally and/or alternatively, the first element fastener can be threaded into the director base.

In some embodiments, the beam director further comprises a second element fastener that is selectively movable between a locked position and an unlocked position to selectively inhibit rotation of the reflective element relative to the director base about the second axis. In such embodiments, the second element fastener moves along an axis that is orthogonal to the second axis during movement between the unlocked position and the locked position.

In one embodiment, the reflective element includes an element end having the reflective surface and an element shaft that cantilevers away from the element end. In such embodiment, the director base can include a shaft aperture that receives the element shaft, the shaft aperture allowing the element shaft to selectively rotate relative to the director base. Additionally, in such embodiment, the first element fastener can selectively adjust a size of the shaft aperture to selectively inhibit rotation of the element shaft within the shaft aperture.

Additionally, in one embodiment, the beam director further comprises (i) a base fastener that selectively clamps the director base to inhibit rotation of the director base and the reflective element relative to the mounting base about the first axis; (ii) a second element fastener that is selectively movable between a locked position and an unlocked position to selectively inhibit rotation of the reflective element relative to the director base about the second axis, the second element fastener moving along an axis that is orthogonal to the second axis during movement between the unlocked position and the locked position, the first element fastener and the second element fastener extending through the director base and being threaded into the reflective element; and (iii) an adjuster that selectively adjusts the position of the reflective element relative to the director base about the second axis. Moreover, in such embodiment, the reflective element is positioned adjacent to the director base, a second interface between the reflective element and the director base is in a second interface plane that is orthogonal to the second axis, and the reflective surface is integral to the reflective element.

Further, in one embodiment, the beam director further comprises (i) a base fastener that selectively clamps the director base to inhibit rotation of the director base and the reflective element relative to the mounting base about the first axis; and (ii) an adjuster that selectively adjusts the position of the reflective element relative to the director base about the second axis. Moreover, in such embodiment, the first element fastener is threaded into the director base; the reflective element includes an element end having the reflective surface and an element shaft that cantilevers away from the element end; the director base includes a shaft aperture that receives the element shaft, the shaft aperture allowing the element shaft to selectively rotate relative to the director base; the first element fastener selectively adjusts a size of the shaft aperture to selectively inhibit rotation of the element shaft within the shaft aperture; a resilient member is positioned adjacent to the shaft aperture, the resilient member urging the element end against the director base; and the reflective surface is integral to the reflective element.

The present invention is further directed toward a laser system including a laser source that generates a beam, and the beam director as described above that directs the beam. Additionally, the present invention is directed toward a laser source assembly including a mounting base, the laser system, as described above, that is secured to the mounting base, and a thermal module that controls the temperature of the mounting base and the laser system.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is simplified side illustration of a laser source assembly having features of the present invention that generates an assembly output beam;

FIG. 2A is a simplified perspective view of an embodiment of the laser source assembly of FIG. 1, the laser source assembly including a mounting base and a laser system;

FIG. 2B is a simplified, partly exploded perspective view of the laser source assembly illustrated in FIG. 2A;

FIG. 3A is a simplified perspective view of the mounting base and the laser system illustrated in FIG. 2A;

FIG. 3B is a simplified top view of the mounting base and the laser system of FIG. 3A;

FIG. 4A is a perspective view of an embodiment of a mirror mount having features of the present invention, the mirror mount including a mirror plate, a base and a tilt clamp;

FIG. 4B is an exploded perspective view of the mirror mount illustrated in FIG. 4A;

FIG. 4C is a perspective view of the mirror mount of FIG. 4A and an eccentric tool that can be used with the present invention;

FIG. 4D is a bottom view of the mirror mount and the eccentric tool illustrated in FIG. 4C;

FIG. 4E is a perspective view of the base illustrated in FIG. 4A;

FIG. 4F is a perspective view of the mirror plate illustrated in FIG. 4A;

FIG. 5A is a perspective view of another embodiment of a mirror mount having features of the present invention, the mirror mount including a mirror shaft, a base and a tip lever;

FIG. 5B is an exploded perspective view of a portion of the mirror mount illustrated in FIG. 5A;

FIG. 5C is an exploded perspective view of the mirror mount illustrated in FIG. 5A;

FIG. 6 is a perspective view of an embodiment of a periscope mount having features of the present invention; and

FIG. 7 is a perspective view of an embodiment of a filter mount having features of the present invention.

### DESCRIPTION

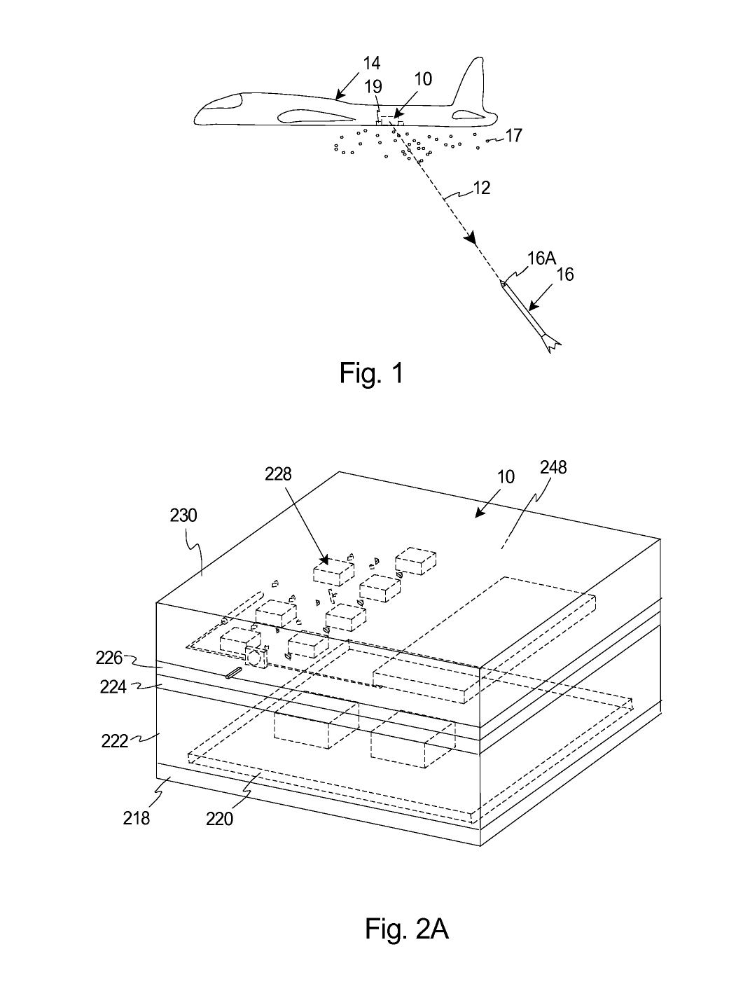

FIG. 1 is simplified side illustration of a laser source assembly 10 (illustrated in phantom) having features of the present invention that generates an assembly output beam 12 (illustrated with a dashed arrow line). There are a number of possible usages for the laser source assembly 10 disclosed herein. For example, as illustrated in FIG. 1, the laser source assembly 10 can be used on an aircraft 14 (e.g., a plane or helicopter) to protect that aircraft 14 from a heat seeking missile 16. In this embodiment, the missile 16 is locked onto the heat emitting from the aircraft 14, and the laser source assembly 10 emits the assembly output beam 12 that protects the aircraft 14 from the missile 16. For example, the assembly output beam 12 can be directed at the missile 16 to jam a guidance system 16A (illustrated as a box in phantom) of the missile 16. In this embodiment, the laser source assembly 10 functions as a jammer of an anti-aircraft missile.

Alternatively, for example, the laser source assembly 10 can be used for a free space communication system in which the laser source assembly 10 is operated in conjunction with an IR detector located far away, to establish a wireless, directed, invisible data link. Still alternatively, the laser source assembly 10 can be used for any application requiring transmittance of directed infrared radiation through the atmosphere at the distance of thousands of meters, to simulate a thermal source to test IR imaging equipment, as an active illuminator to assist imaging equipment, or any other application.

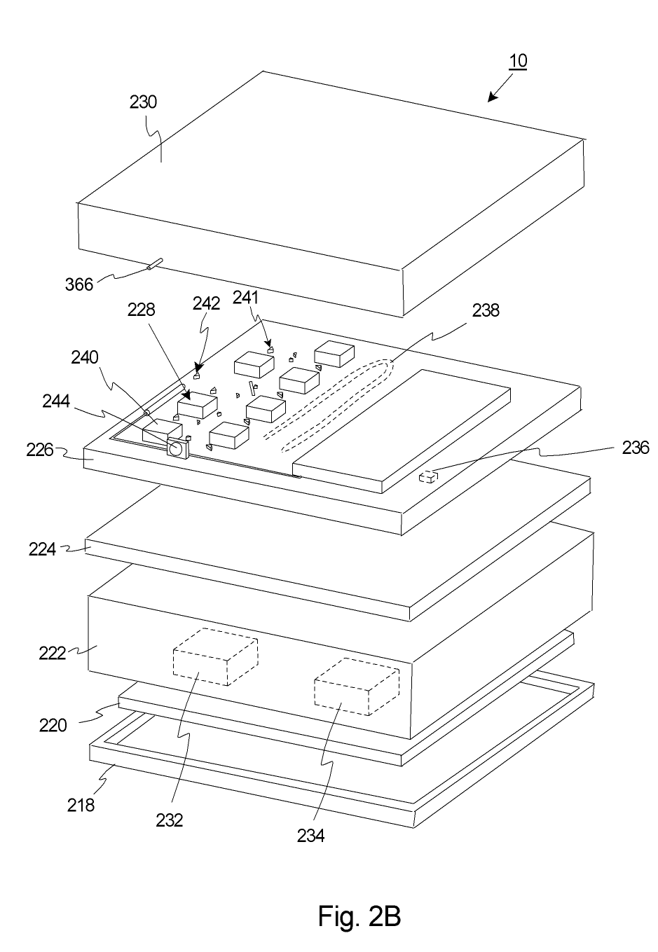

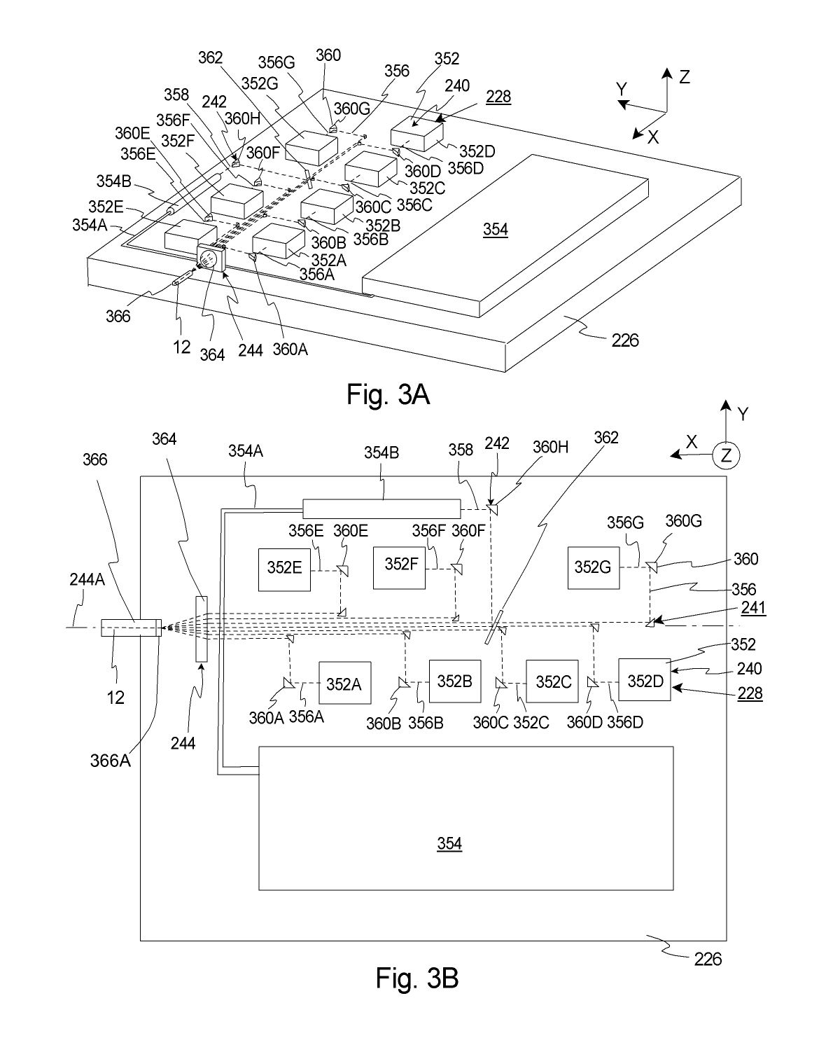

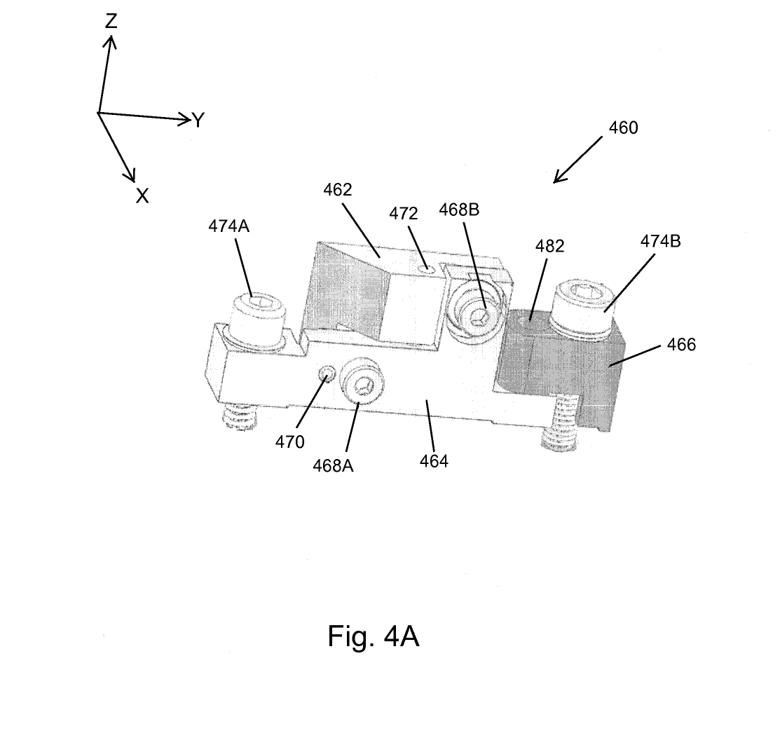

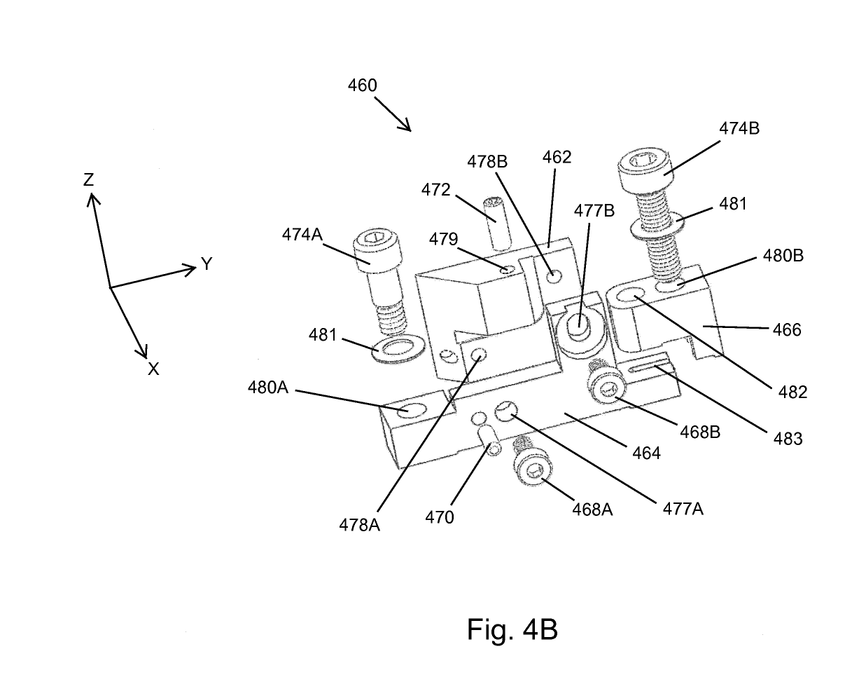

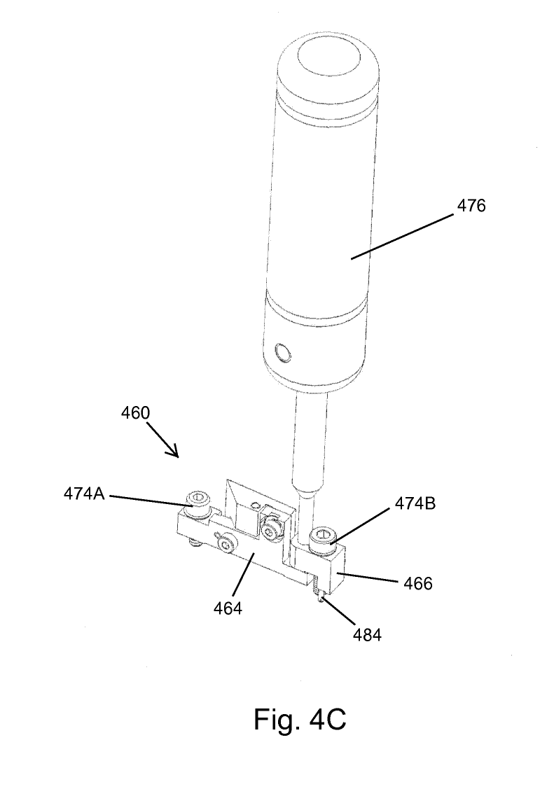

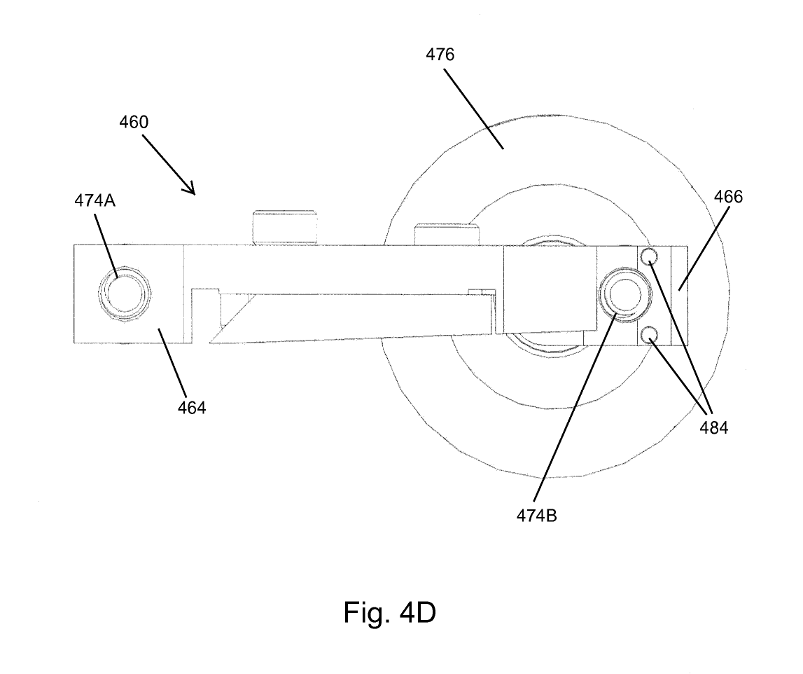

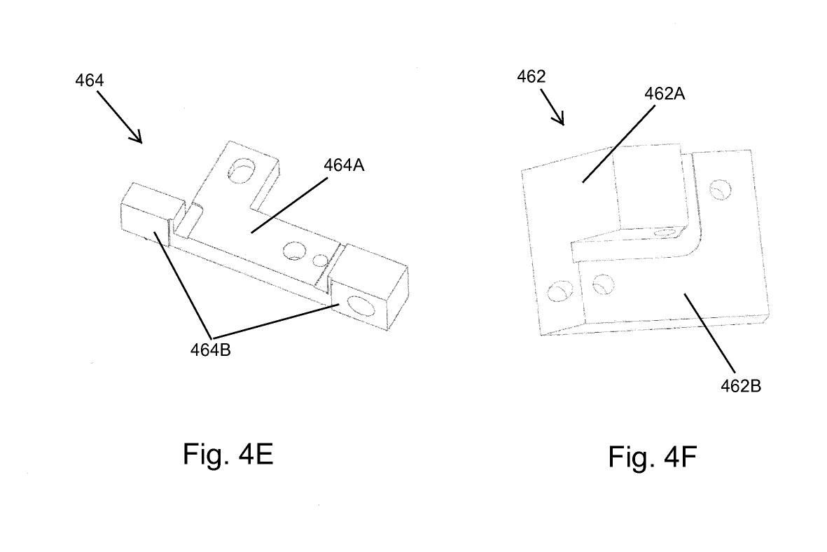

As an overview, in certain embodiments, the laser source assembly 10 includes one or more beam directors, e.g., mirror mounts 460 (illustrated in FIG. 4A), to precisely steer one or more beams 356, 358 (illustrated in FIG. 3A) from one or more laser sources 240 (illustrated in FIG. 2B) to create the assembly output beam 12. The plurality of laser sources 240 can be packaged in a portable, common module. In alternative such embodiments, the plurality of laser sources 240 can include a plurality of mid-infrared (MIR) laser sources 352 (illustrated in FIG. 3A) and/or the plurality of laser sources 240 can include one or more non-MIR laser sources 354 (illustrated in FIG. 3A). Each of the laser sources 240 generates a narrow linewidth, accurately settable beam, i.e. the MIR laser sources 352 generate a narrow linewidth, accurately settable MIR beam 356 (illustrated in FIG. 3A), and/or the non-MIR laser sources 354 generate a narrow linewidth, accurately settable non-MIR beam 358 (illustrated in FIG. 3A), and the beams 356, 358 are then combined to create the assembly output beam 12. Further, each of the laser sources 240 can be a single emitter infrared semiconductor laser. As a result thereof, utilizing multiple single emitter infrared semiconductor lasers, the laser source assembly 10 can generate a multiple watt, assembly output beam 12. The exact wavelength of the MIR beams 356 and/or the non-MIR beams 358 that effectively jams the guidance system 16A is uncertain and/or can vary depending on the specifications of the missile 16 and the guidance system 16A. However, with the present invention, the laser sources 240 can be accurately tuned to the appropriate wavelength for jamming the guidance system 16A.

Another important aspect of the beams 356, 358 is the ability propagate through the atmosphere 17 (illustrated as small circles) with minimal absorption. Typically, absorption in the atmosphere 17 is primarily due to the presence of water and carbon dioxide in the atmosphere 17. Atmospheric propagation requires narrow linewidth and accurate settable wavelength to avoid absorption. With the present invention, each of the laser sources 240 generates a narrow linewidth beam 356, 358 and each of the laser sources 240 can be individually tuned so that each beam 356, 358 is at a wavelength that allows for maximum transmission through the atmosphere 17. Stated in another fashion, the wavelength of each beam 356, 358 is specifically selected to avoid the wavelengths that are readily absorbed by water or carbon dioxide.

Further, in one embodiment, the laser source assembly 10 can include one or more vibration isolators 19 that isolate the components of the laser source assembly 10 from vibration.

A number of Figures include an orientation system that illustrates an X axis, a Y axis that is orthogonal to the X axis and a Z axis that is orthogonal to the X and Y axes. It should be noted that these axes can also be referred to as the first, second and third axes.

FIG. 2A is a simplified perspective view of an embodiment of the laser source assembly 10 of FIG. 1. The design, size and shape of the laser source assembly 10 can be varied pursuant to the teachings provided herein. In FIG. 2A, the laser source assembly 10 is generally rectangular box shaped and includes a bottom cover 218, a system controller 220 (illustrated in phantom) that is stacked on the bottom cover 218, a thermal module 222 that is stacked on the system controller 220, an insulator 224 that is stacked on top of the thermal module 222, a mounting base 226 that is stacked on top of the insulator 224, a laser system 228 that is secured to the mounting base 226, and a cover 230 that covers the laser system 228. Alternatively, the laser source assembly 10 can be designed with more or fewer components than are illustrated in FIG. 2A and/or the arrangement of these components can be different than that illustrated in FIG. 2A. Further, the size and shape of these components can be different than that illustrated in FIG. 2A.

It should be noted that the laser source assembly 10 can be powered by a generator, e.g., the generator for the aircraft 14 (illustrated in FIG. 1), a battery, or another power source.

FIG. 2B is a simplified, partly exploded perspective view of the laser source assembly 10 illustrated in FIG. 2A. In this embodiment, the bottom cover 218 is rigid, and is shaped somewhat similar to an inverted top to a box. Alternatively, the bottom cover 218 can have another suitable configuration. Additionally, the bottom cover 218 can include one or more vents (not shown) for venting some of the components of the laser source assembly 10.

The system controller 220 controls the operation of the thermal module 222 and the laser system 228. For example, the system controller 220 can include one or more processors and circuits. In certain embodiments, the system controller 220 can control the electron injection current that is directed to the individual laser sources 240 of the laser system 228. Additionally, in certain embodiments, the system controller 220 can control the operation of the thermal module 222 so as to control the temperature of the mounting base 226 and the laser system 228. With this design, the system controller 220 enables the user to remotely change the characteristics of the assembly output beam 12 (illustrated in FIG. 1).

The thermal module 222 controls the temperature of the mounting base 226 and the laser system 228. For example, as shown in FIG. 2B, the thermal module 222 can include a heater 232 (illustrated in phantom) and a chiller 234 (illustrated in phantom) to selectively adjust the temperature of the mounting base 226 and/or the laser system 228 as necessary. Additionally, the thermal module 222 can utilize a temperature sensor 236 (illustrated in phantom), e.g., a thermistor, to sense the temperature of the mounting base 226 and/or the laser system 228. For example, in one embodiment, the temperature sensor 236 is positioned on and/or adjacent to the mounting base 226, and the temperature sensor 236 provides feedback regarding the temperature of the mounting base 226. The system controller 220 receives the feedback from the temperature sensor 236 to control the operation of the thermal module 222. With this design, the thermal module 222 is used to directly control the temperature of the mounting base 226 so that the mounting base 226 is maintained at a predetermined temperature. In one non-exclusive embodiment, the predetermined temperature is approximately 25 degrees Celsius. By maintaining the mounting base 226 at a predetermined temperature, the thermal module 222 can be used to effectively control the temperature of the components of the laser system 228.

In one embodiment, the thermal module 222 is designed to selectively circulate hot or cold circulation fluid (not shown) through the mounting base 226 to control the temperature of the mounting base 226, i.e. to maintain the mounting base 226 at the predetermined temperature. In the embodiment illustrated in FIG. 2B, the heater 232 and the chiller 234 are used to control the temperature of the circulation fluid that is circulated through the mounting base 226. Alternatively, the thermal module 222 can be in direct thermal contact with the mounting base 226.

Additionally, or alternatively, the thermal module 222 can also include one or more cooling fans and vents to further remove the heat generated by the operation of the laser source assembly 10.

The insulator 224 is positioned between the mounting base 226 and the thermal module 222. Moreover, the insulator 224 thermally isolates the thermal module 222 from the mounting base 226, while allowing the thermal module 222 to circulate the circulation fluid through the mounting base 226.

The mounting base 226 provides a rigid, one piece platform to support the various components of the laser system 228 and to maintain the relative position of the various components of the laser system 228. In one non-exclusive embodiment, the mounting base 226 is monolithic, and generally rectangular plate shaped. Further, as illustrated, the mounting base 226 can include a plurality of embedded base passageways 238 (only a portion of which is illustrated in phantom) that allow for the circulation of the hot and/or cold circulation fluid through the mounting base 226 to maintain the temperature of the mounting base 226 and the components of the laser system 228 that are mounted thereon. The mounting base 226 can also be referred to as a cold plate.

Non-exclusive examples of suitable materials for the mounting base 226 include magnesium, aluminum, and carbon fiber composite.

The laser system 228 generates the assembly output beam 12 (illustrated in FIG. 1). The design of the laser system 228 and the components used therein can be varied pursuant to the teachings provided herein. In one embodiment, the laser system 228 includes a plurality of spaced apart, individual laser sources 240, and a beam combiner 241.

Each of the laser sources 240 is fixedly secured to the mounting base 226. As noted above, the plurality of laser sources 240 can include a plurality of MIR laser sources 352 (illustrated in FIG. 3A) and/or the plurality of laser sources 240 can include one or more non-MIR laser sources 354 (illustrated in FIG. 3A). Additionally, each of the laser sources 240 generates a beam, i.e. the MIR laser sources 352 generate an MIR beam 356 (illustrated in FIG. 3A), and/or the non-MIR laser sources 354 generate a non-MIR beam 358 (illustrated in FIG. 3A).

The beam combiner 241 combines the beams 356, 358 that are generated from each of the laser sources 240. The design of the beam combiner 241 can be varied. In the embodiment illustrated in FIG. 2B, the beam combiner 241 includes a beam director assembly 242 that is fixedly secured to the mounting base 226, and a beam focus assembly 244.

The laser system 228 will be described in more detail below.

The cover 230 covers the laser system 228 and provides a controlled environment for the laser system 228. More specifically, the cover 230 can cooperate with the mounting base 226 to define a sealed laser chamber 248 (illustrated in FIG. 2A) that encloses the laser sources 240. Further, an environment in the sealed laser chamber 248 can be controlled. For example, the sealed laser chamber 248 can be filled with an inert gas, or another type of fluid, or the sealed laser chamber 248 can be subjected to vacuum. In one embodiment, the cover 230 is rigid, and is shaped somewhat similar to a top to a box.

FIG. 3A is a simplified perspective view and FIG. 3B is a simplified top view of the mounting base 226 and the laser system 228. In this embodiment, the laser system 228 includes the plurality of laser sources 240 and the beam combiner 241.

The number and design of the laser sources 240 can be varied to achieve the desired characteristics of the assembly output beam 12 (illustrated as a dashed line). In FIGS. 3A and 3B, the laser system 228 includes eight separate, spaced apart laser sources 240 that are fixedly secured to the top of the mounting base 226. In this embodiment, seven of the laser sources 240 are MIR laser sources 352 and one of the laser sources 240 is a non-MIR laser source 354. Alternatively, the laser system 228 can be designed to have more or fewer than seven MIR laser sources 352, and/or more than one or zero non-MIR laser sources 354. For example, in alternative, non-exclusive embodiments, the laser system 228 can include three or eighteen separate MIR laser sources 352. It should be noted that the power output and other characteristics of the assembly output beam 12 can be adjusted by changing the number of MIR laser sources 352.

In the embodiment illustrated in FIGS. 3A and 3B, each of the MIR laser sources 352 generates a separate MIR beam 356 (illustrated as a dashed line) having a center wavelength that is within the MIR range, and the non-MIR laser source 354 generates a non-MIR beam 358 (illustrated as a dashed line) having a center wavelength that is outside the MIR range. In one non-exclusive embodiment, each MIR beam 356 can have a center wavelength of approximately 4.6 μm, and the non-MIR beam 358 can have a center wavelength of approximately 2.0 μm.

In certain embodiments, each MIR laser source 352 is an external cavity, quantum cascade laser that is packaged in a common, thermally stabilized and opto-mechanically stable assembly along with integrated beam combining optics that allow for spectrally or spatially combining of the outputs of the multiple external cavity, quantum cascade lasers.

It should be noted that in this embodiment, the seven MIR laser sources 352 can be labeled (i) a first MIR source 352A that generates a first MIR beam 356A, (ii) a second MIR source 352B that generates a second MIR beam 356B, (iii) a third MIR source 352C that generates a third MIR beam 356C, (iv) a fourth MIR source 352D that generates a fourth MIR beam 356D, (v) a fifth MIR source 352E that generates a fifth MIR beam 356E, (vi) a sixth MIR source 352F that generates a sixth MIR beam 356F, and (vii) a seventh MIR source 352G that generates a seventh MIR beam 356G.

As provided herein, each of the MIR laser sources 352 can be individually tuned so that a specific wavelength of the MIR beams 356 of one or more of the MIR laser sources 352 is the same or different than that of the other MIR beams 356. Thus, the MIR laser sources 352 can be tuned so that the portion of the assembly output beam 12 generated by the MIR laser sources 352 is primarily a single wavelength beam or is primarily a multiple wavelength (incoherent) beam. In one non-exclusive example, each of the MIR laser sources 352A-352G can be tuned so that each MIR beam 356A-356G has a center wavelength of approximately 4.6 μm.

In one non-exclusive, alternative example, (i) the first MIR source 352A can be tuned so that the first MIR beam 356A has a center wavelength of approximately 4.1 μm, (ii) the second MIR source 352B can be tuned so that the second MIR beam 356B has a center wavelength of approximately 4.2 μm, (iii) the third MIR source 352C can be tuned so that the third MIR beam 356C has a center wavelength of approximately 4.3 μm, (iv) the fourth MIR source 352D can be tuned so that the fourth MIR beam 356D has a center wavelength of approximately 4.4 μm, (v) the fifth MIR source 352E can be tuned so that the fifth MIR beam 356E has a center wavelength of approximately 4.5 μm, (vi) the sixth MIR source 352F can be tuned so that the sixth MIR beam 356F has a center wavelength of approximately 4.6 μm, and (vii) the seventh MIR source 352G can be tuned so that the seventh MIR beam 356G has a center wavelength of approximately 4.7 μm.

It should be noted that the exact wavelength of the MIR beams 356A-356G and the non-MIR beam 358 can be selected so that the resulting assembly output beam 12 propagates through the atmosphere 17 (illustrated in FIG. 1) with minimal absorption.

Further, it should be noted that each MIR laser source 352 can generate an MIR beam 356 having a power of between approximately 0.5 and 3 watts. As a result thereof, the seven MIR laser sources 352A-352G can generate a combined power of between approximately 3.5 and 21 watts.

With the designs provided herein, each MIR beam 356A-356G has a relatively narrow linewidth. In non-exclusive examples, the MIR laser sources 352A-352G can be designed so that the linewidth of each MIR beam 356A-356G is less than approximately 5, 4, 3, 2, 1, 0.8, 0.5, or 0.1 cm⁻¹. Alternatively, the MIR laser sources 352A-352G can be designed so that the linewidth of each MIR beam 356A-356G is greater than approximately 7, 8, 9, or 10 cm⁻¹. The spectral width of the MIR beams 356A-356G can be adjusted by adjusting the cavity parameters of the external cavity of the respective MIR laser sources 352A-352G. For example, the spectral width of the MIR beams 356A-356G can be increased by decreasing wavelength dispersion of intracavity wavelength selector.

Each MIR laser source 352 can also be referred to as a Band 4 laser source. In one embodiment, one or more of the MIR laser sources 352 can include a Quantum Cascade gain medium that generates a laser beam that is in the mid-infrared range. With this design, electrons transmitted through the QC gain medium emit one photon at each of the energy steps. In the case of a QC gain medium, the “diode” has been replaced by a conduction band quantum well. Electrons are injected into the upper quantum well state and collected from the lower state using a superlattice structure. The upper and lower states are both within the conduction band. Replacing the diode with a single-carrier quantum well system means that the generated photon energy is no longer tied to the material bandgap. This removes the requirement for exotic new materials for each wavelength, and also removes Auger recombination as a problem issue in the active region. The superlattice and quantum well can be designed to provide lasing at almost any photon energy that is sufficiently below the conduction band quantum well barrier. In one, non-exclusive embodiment, the semiconductor QCL laser chip is mounted epitaxial growth side down. A suitable QC gain medium can be purchased from Alpes Lasers, located in Switzerland.

Alternatively, for example, one or more of the MIR laser sources 352 can include an Interband Cascade (“IC”) gain medium. IC gain medium use a conduction-band to valence-band transition as in the traditional diode laser.

As used herein, the term mid-infrared range has a wavelength in the range of approximately 3-14 microns.

In certain embodiments, one or more of the MIR laser sources 352 can be tuned to adjust the primary wavelength of the laser beam. For example, one or more of the MIR laser sources 352 can include a wavelength selective element (not shown) that allows the wavelength of the laser beam to be individually tuned. The design of the wavelength selective element can vary. Non-exclusive examples of suitable wavelength selective elements include a diffraction grating, a MEMS grating, prism pairs, a thin film filter stack with a reflector, an acoustic optic modulator, or an electro-optic modulator. Further, a wavelength selective element can be incorporated into the gain medium. A more complete discussion of these types of wavelength selective elements can be found in the Tunable Laser Handbook, Academic Press, Inc., Copyright 1995, chapter 8, Pages 349-435, Paul Zorabedian, the contents of which are incorporated herein by reference.

Additionally, one embodiment of a suitable non-MIR laser source 354 is a diode-pumped Thulium-doped fiber laser. A suitable non-MIR laser source 354 can be purchased from IPG Photonics, located in Oxford, Mass. The non-MIR laser source 354 can also be referred to as a Band I laser source. In one embodiment, the non-MIR laser source 354 generates a non-MIR beam 358 having a power of between approximately one to ten watts, and a linewidth of less than approximately 2.5 cm⁻¹.

Further, as shown in the embodiment illustrated in FIGS. 3A and 3B, the non-MIR laser source 354 can include a non-MIR optical fiber 354A that guides the non-MIR beam 358 from the body of the non-MIR laser source 354, and a fiber collimator 354B that collimates and launches the non-MIR beam 358.

The beam combiner 241 combines the multiple MIR beams 356 and the non-MIR beam 358. In the embodiment illustrated in FIGS. 3A and 3B, the beam combiner 241 includes the beam director assembly 242 and the beam focus assembly 244. Alternatively, for example, the beam combiner 241 can be designed without the beam focus assembly 244.

The beam director assembly 242 directs and steers the MIR beams 356 and the non-MIR beam 358 at the beam focus assembly 244. As provided herein, in one embodiment, the beam director assembly 242 directs the MIR beams 356 and the non-MIR beam 358 at the beam focus assembly 244 in a substantially parallel arrangement with a combiner axis 244A of the beam focus assembly 244. Stated in another fashion, the beam director assembly 242 combines the MIR beams 356 and the non-MIR beam 358 by directing the beams 356, 358 to be parallel to each other (i.e. so that the beams 356, 358 travel along parallel axes). Further, the beam director assembly 242 causes the MIR beams 356 and the non-MIR beam 358 to be directed in the same direction, with the beams 356, 358 overlapping, or being adjacent to each other.

In one embodiment, the beam director assembly 242 can include a plurality of beam directors 360 (e.g., mirror mounts) and a dichroic filter 362 that are secured to the mounting base 226. Each beam director 360 can be a beam steering prism that includes a coating that reflects light in the MIR range. For example, suitable materials for each of the beam directors 360 can be magnesium, aluminum, and carbon fiber composite, and each beam director 360 can include a polished, gold-plated, reflective surface. Further, the dichroic filter 362 can transmit beams in the MIR range while reflecting beams in the non-MIR range. Stated in another fashion, the dichroic filter 362 can transmit the MIR beams 356 and reflect the non-MIR beam 358. More specifically, in this embodiment, the dichroic filter 362 reflects the non-MIR beam 358, and transmits the third, fourth and seventh MIR beams 356C, 356D, 356G.

More particularly, as shown in the embodiment illustrated in FIGS. 3A and 3B, the beam director assembly 242 can include (i) a pair of first beam directors 360A that cooperate to steer the first MIR beam 356A to be approximately parallel to and adjacent to the combiner axis 244A; (ii) a pair of second beam directors 360B that cooperate to steer the second MIR beam 356B to be approximately parallel to and adjacent to the combiner axis 244A; (iii) a pair of third beam directors 360C that cooperate to steer the third MIR beam 356C to be approximately parallel to and adjacent to the combiner axis 244A; (iv) a pair of fourth beam directors 360D that cooperate to steer the fourth MIR beam 356D to be approximately coaxial with the combiner axis 244A; (v) a pair of fifth beam directors 360E that cooperate to steer the fifth MIR beam 356E to be approximately parallel to and adjacent to the combiner axis 244A; (vi) a pair of sixth beam directors 360F that cooperate to steer the sixth MIR beam 356F to be approximately parallel to and adjacent to the combiner axis 244A; (vii) a pair of seventh beam directors 360G that cooperate to steer the seventh MIR beam 356G to be approximately parallel to and adjacent to the combiner axis 244A; and (vii) an eighth beam director 360H and the dichroic filter 362 that cooperate to steer the non-MIR beam 358 to be approximately coaxial with the combiner axis 244A. Further, in this embodiment, each of the beams 356A-356G are controlled by the beam director assembly 242 to be directed in the same direction (i.e. at the beam focus assembly 244).

In one embodiment, the individual MIR beams 356A-356G and the non-MIR beam 358 are steered to co-propagate parallel to each other, with the distance between the beam centers of each of the MIR beams 356A-356G being close to the individual beam diameter of each of the MIR beams 356A-356G. With this design, the beams 356A-356G, 358 propagate along parallel axes.

It should be noted that one or more of the beam directors 360A-360H and/or the dichroic filter 362 can be mounted to the mounting base 226 in a fashion that allows that respective component to be accurately and individually moved relative to the mounting base 226 about the Z axis and about the X axis. With this design, the beam directors 360A-360H and/or the dichroic filter 362 can be accurately rotated to properly direct the respective beam at the beam focus assembly 244.

The beam focus assembly 244 spatially combines and optically multiplexes the MIR beams 356A-356G and the non-MIR beam 358 to provide the assembly output beam 12. In one embodiment, the beam focus assembly 244 includes a combiner lens 364 and an output optical fiber 366. The design of the combiner lens 364 and the output optical fiber 366 can vary pursuant to the teachings provided herein.

In one embodiment, the combiner lens 364 is a spherical lens having an optical axis that is aligned with the combiner axis 244A. Alternatively, the combiner lens 364 may be aspherical.

In one embodiment, to achieve the desired small size and portability, the combiner lens 364 has a relatively small diameter. In alternative, non-exclusive embodiments, the combiner lens 364 has a diameter of less than approximately 10 or 15 millimeters, and a focal length of approximately 1, 2, 3, 4, 5, 6, 7, 8, 9, 10, 11, 12, 13, 14, 15, 16, 17, 18, 19, 20, 21, 22, 23, 24 or 25 mm and any fractional values thereof. The combiner lens 364 can comprise materials selected from the group of Ge, ZnSe, ZnS Si, CaF, BaF or chalcogenide glass. However, other materials may also be utilized that are effective with the wavelengths of the MIR beams 356A-356G and the non-MIR beam 358. Further, the lens can be designed to have a numerical aperture (NA) which matches that of the output optical fiber 366 and to have a clear aperture that matches the diameter of a combined beam pattern. In one embodiment, the combiner lens 364 is secured to the mounting base 226.

Additionally, in one embodiment, the single combiner lens 364 focuses the MIR beams 356A-356G and the non-MIR beam 358 onto a fiber facet 366A of the output optical fiber 366 to spatially combine these beams 356A-356G, 358 into the assembly output beam 12. In one embodiment, the output optical fiber 366 is a multi-mode fiber that transmits the multiple mode, assembly output beam 12. Additionally, as illustrated in FIG. 2B, the output optical fiber 366 can extend through a hole (not illustrated) in the cover 230 of the laser source assembly 10.

A more detailed description of a high output mid infrared laser source assembly can be found in U.S. application Ser. No. 12/427,364, filed on Apr. 21, 2009, and entitled “High Output, Mid Infrared Laser Source Assembly”. As far as is permitted, the contents of U.S. application Ser. No. 12/427,364 are incorporated herein by reference.

FIG. 4A is a perspective view of an embodiment of a suitable beam director, e.g., a mirror mount 460, having features of the present invention. As provided herein, the mirror mount 460 provides various stability features for the laser system 228 (illustrated in FIG. 2A).

The design of the mirror mount 460 can be varied to suit the specific requirements of the laser system 228. In certain embodiments, the present invention is directed toward a two-axis mirror mount 460 that has exceptional (<50-100 urad) long term pointing stability, that is stable over extreme temperature soaks (−55 to 85 C), and that is stable over shock and vibration. More particularly, in certain embodiments, the mirror mount 460 can be designed to provide tip (rotation about the X axis) and tilt (rotation about the Z axis) adjustments to enable the mirror mount 460 to precisely steer the MIR beams 356 (illustrated in FIG. 3A) and/or the non-MIR beam 358 (illustrated in FIG. 3A) toward the combiner lens 364 (illustrated in FIG. 3A).

As noted above, the mirror mount 460 can be secured to the mounting base 226 (illustrated in FIG. 2A). In this embodiment, the mirror mount 460 includes a mirror plate 462 having a plate reflective surface 462A, a director base 464 (also referred to herein as a “base”) and a tilt clamp 466 that are adjustably coupled together so as to enable precise tip and tilt adjustments of the mirror plate 462 and the plate reflective surface 462A relative to the mounting base 226. In one embodiment, the plate reflective surface 462A is a polished, gold-plated surface formed on an aluminum mirror plate 462.

It should be noted that the mirror plate 462 can be referred to generically as a reflective element and the tilt clamp 466 can be referred to generically as a rotation adjustment element.

In one embodiment, the mirror plate 462, the base 464 and the mounting base 226 can all be made of the same or very similar material. For example, in one embodiment, each of the mirror plate 462, the base 464 and the mounting base 226 can be made of an aluminum material. As a result thereof, there is no or very little coefficient of thermal expansion (“CTE”) mismatch, which enables the mirror mount 460 to exhibit improved stability during use.

In the embodiment illustrated in FIG. 4A, precise tip adjustment of the reflective surface 462A of the mirror mount 460 can be accomplished through the use of a first element fastener 468A, a second element fastener 468B, an element pivot 470 (e.g. a dowel pin or pivot pin), and an adjuster 472. As illustrated herein, in on embodiment, each element fastener 468A, 468B can be a locking screw. Alternatively, the element fasteners 468A, 468B can have a different design.

Each of the first element fastener 468A and the second element fastener 468B extends through the base 464 and threads into the mirror plate 462 to selectively fixedly secure or clamp the mirror plate 462 to the base 464. In particular, each of the first element fastener 468A and the second element fastener 468B are selectively movable between a locked position and an unlocked position to selectively inhibit rotation of the mirror plate 462 relative to the base 464 about the X axis. Further, each of the first element fastener 468A and the second element fastener 468B move along an axis that is orthogonal to the X axis during movement between the unlocked position and the locked position.

Additionally, the element pivot 470 provides a rotation axis guide for tip adjustment of the mirror plate 462 and the reflective surface 462A relative to the base 464. With this design, the element fasteners 468A, 468B can be loosened, i.e. moved from the locked position to the unlocked position, to allow the mirror plate 462 and the reflective surface 462A to be rotated or pivoted about the element pivot 470 (about the X axis) relative to the base 464, and the element fasteners 468A, 468B can be subsequently tightened, i.e. moved from the unlocked position to the locked position, to fixedly secure or clamp the mirror plate 462 to the base 464. As the element pivot 470 functions as the pivot point about which the mirror plate 462, i.e. the reflective element, rotates relative to the base 464, the element pivot 470 is also sometimes referred to as an element pivot.

Further, the adjuster 472 can be a screw that is threaded into and through the mirror plate 462 so that a distal tip of the adjuster 472 can engage the base 464, and, thus, be used to move the mirror plate 462 relative to the base 464 when the fasteners 468A, 468B have been loosened. Additionally, a spring (not shown) or other resilient member can be implemented between the mirror plate 462 and the base 464 to urge the mirror plate 462 and the distal tip of the adjuster 472 against the base 464.

Additionally, in this embodiment, precise tilt adjustment of the reflective surface 462A of the mirror mount 460 can be accomplished through the use of a base pivot 474A and a base fastener 474B (also referred to herein as a “fastener”), and an eccentric tilt adjustment tool 476 (illustrated in FIGS. 4C and 4D).

In one embodiment, the base pivot 474A can be fixedly secured to, i.e. threaded into, the mounting base 226, and the base fastener 474B can be a locking screw that is selectively threaded into the mounting base 226. In particular, each of the base pivot 474A and the base fastener 474B are selectively movable between a locked position and an unlocked position to selectively inhibit rotation of the base 464 relative to the mounting base 226 about the Z axis. Further, each of the base pivot 474A and the base fastener 474B move along an axis that is orthogonal to the Z axis during movement between the unlocked position and the locked position.

In this embodiment, to adjust the tilt, both the base pivot 474A and the base fastener 474B are loosened, i.e. are moved from the locked position to the unlocked position. This allows the base 464 to pivot about the base pivot 474A. Alternatively, one or both of the base pivot 474A and the base fastener 474B can have a different design. As shown in FIG. 4A, the base pivot 474A extends through the base 464 and the base fastener 474B extends through the tilt clamp 466 to secure the mirror mount 460 to the mounting base 226. Tilt adjustment will be described in greater detail below.

FIG. 4B is an exploded perspective view of the mirror mount 460 illustrated in FIG. 4A. In particular, FIG. 4B more clearly illustrates the connections between the mirror plate 462 and the base 464, and between the mirror mount 460 and the mounting base 226 (illustrated in FIG. 2A).

In this embodiment, the element fasteners 468A, 468B extend through tip base apertures 477A, 477B, respectively, and are threaded into tip plate apertures 478A, 478B, respectively, in the mirror plate 462. With this design, as noted above, the element fasteners 468A, 468B can be loosened, i.e. moved from the locked position to the unlocked position, to allow the mirror plate 462 to be rotated about the element pivot 470 (about the X axis) relative to the base 464 and subsequently tightened, i.e. moved from the unlocked position to the locked position, to fixedly secure the mirror plate 462 to the base 464. Additionally, the adjuster 472 is threaded into and through the mirror plate 462 via a plate adjustment aperture 479, and the adjustable screw can then engage the base 464 to move, i.e. tip, the mirror plate 462 relative to the base 464.

Additionally, in this embodiment, the base pivot 474A extends through a tilt base aperture 480A in the base 464, and the base fastener 474B extends through a tilt clamp aperture 480B in the tilt clamp 466. The base pivot 474A and the base fastener 474B are then threaded into the mounting base 226 to secure the mirror mount 460 to the mounting base 226. Further, a preload washer 481 can be utilized with each of the base pivot 474A and the base fastener 474B. Moreover, the base pivot 474A acts as a shoulder bolt that provides a rotational axis guide for tilt adjustment of the reflective surface 462A about the Z axis.

FIG. 4C is a perspective view of the mirror mount 460 and the eccentric tool 476 that can be used with the present invention. Additionally, FIG. 4D is a bottom view of the mirror mount 460 and the eccentric tool 476. In one non-exclusive embodiment, tilt actuation can be done via the eccentric tool 476, which operates in a hole 482 (illustrated in FIGS. 4A and 4B) in the tip clamp 466 and a groove 483 (illustrated in FIG. 4B) in the base 464. In this embodiment, the tool 476 has a cylindrical region that engages the hole 482 and an eccentric region that engages the groove 483. With this design, when the base fastener 474B is loosened, i.e. is moved from the locked position to the unlocked position, the tool 476 can be rotated to tilt the base 464 relative to the mounting base 226. Subsequently, the base fastener 474B can be tightened, i.e. moved from the unlocked position to the locked position, to secure or clamp the base 464 to the mounting base 226. Further, it should be noted that the tilt clamp 466 can include a pair of spaced apart pins 484 that fit into apertures (not shown) in the mounting base 226 to maintain the tilt clamp 466 in the proper position during tilt adjustment of the mirror mount 460. With this design, the tilt clamp 466 does not move relative to the mounting base 226 during tilt adjustment, but the base 464 can be selectively moved relative to the tilt clamp 466 with the eccentric tool 476. It should be noted that the pins 484 can be deformed during tightening of the tilt clamp 466.

It should also be noted that the tilt adjustment of the mirror mount 460 can be performed in another fashion, e.g., utilizing a mechanism (not shown) attached to the mounting base 226 that tilts the tilt clamp 466.

FIG. 4E is a perspective view of the base 464 illustrated in FIG. 4A. In particular, FIG. 4E clearly illustrates a base tip interface surface 464A and a base tilt interface surface 464B of the base 464. The base tip interface surface 464A interfaces with a portion of the mirror plate 462 (illustrated in FIG. 4A) and provides a sliding and locking interface plane for tip adjustments of the mirror mount 460 (illustrated in FIG. 4A). The base tilt interface surface 464B interfaces with the upper surface of the mounting base 226 (illustrated in FIG. 2A) and provides a sliding and locking interface plane for tilt adjustments of the mirror mount 460.

FIG. 4F is a perspective view of the mirror plate 462 illustrated in FIG. 4A. As illustrated, the mirror plate 462 includes the plate reflective surface 462A and a plate tip interface surface 462B.

In this embodiment, the plate reflective surface 462A is integral to the mirror plate 462. Thus, there is no glue and no mechanical joints that connect the plate reflective surface 462A to the rest of the mirror plate 462, which enables the mirror mount 460 (illustrated in FIG. 4A) to exhibit improved stability during use.

Additionally, the plate tip interface surface 462B interfaces with the base tip interface surface 464A (illustrated in FIG. 4E) provides a sliding and locking interface plane for tip adjustments of the mirror mount 460.

Referring back to FIGS. 4A and 4B, moreover, the sliding and locking interface planes, i.e. the planes of the base tip interface surface 464A (illustrated in FIG. 4E) and a base tilt interface surface 464B (illustrated in FIG. 4E) of the base 464, and the plate tip interface surface 462B (illustrated in FIG. 4F) of the mirror plate 462, are orthogonal to axes of rotation. For example, (i) the tip adjustment occurs at a tip interface between the mirror plate 462 and the base 464, i.e. at the interface between the plate tip interface surface 462B and the base tip interface surface 464A, and (ii) the tilt adjustment occurs at a tilt interface between the base 464 and the mounting base 226, i.e. between the base tilt interface surface 464B and the upper surface of the mounting base 226. Further, the tip interface (positioned in the Y-Z plane) is orthogonal to the axis of rotation (about the X axis via the element pivot 470) during tip adjustment, and the tilt interface (positioned in the X-Y plane) is orthogonal to axes of rotation (about the Z axis via the first tilt locking screw 474A) during tilt adjustment. With this design, the mirror mount 460 is able to exhibit improved stability during use.

Additionally, (i) the element fasteners 468A, 468B that lock the tip interface (e.g., that secure the mirror plate 462 to the base 464) are oriented and/or move along an axis that is orthogonal to the tip interface plane, and (ii) the base pivot 474A and the base fastener 474B that lock the tilt interface (e.g., that secure the base 464 to the mounting base 226) are oriented and/or move along an axis that is orthogonal to the tilt interface plane. As a result thereof, any CTE mismatch of fasteners 468A, 468B, 474B or pivot 474A is out-of-plane and therefore does not affect long-term stability.

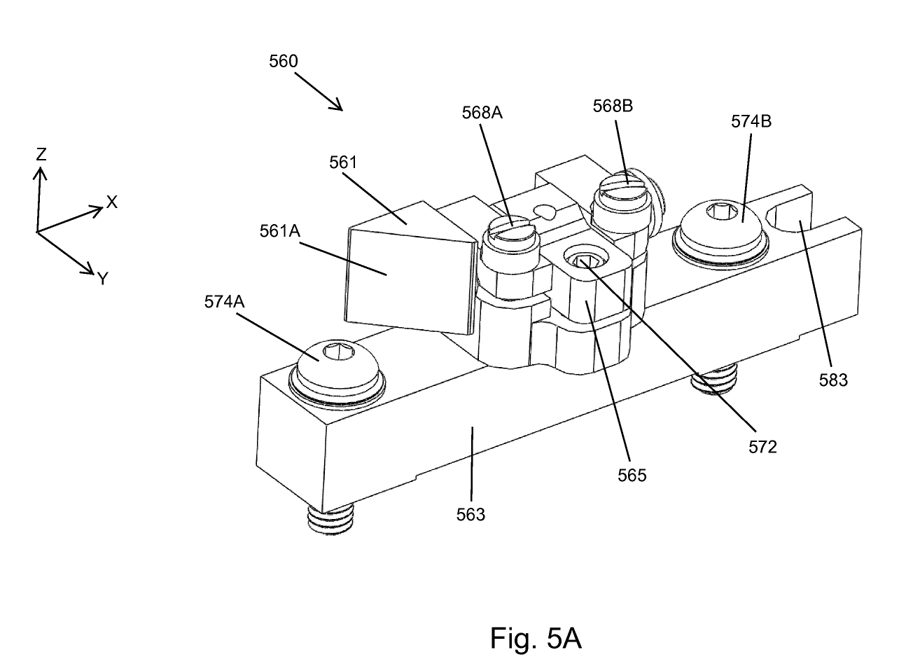

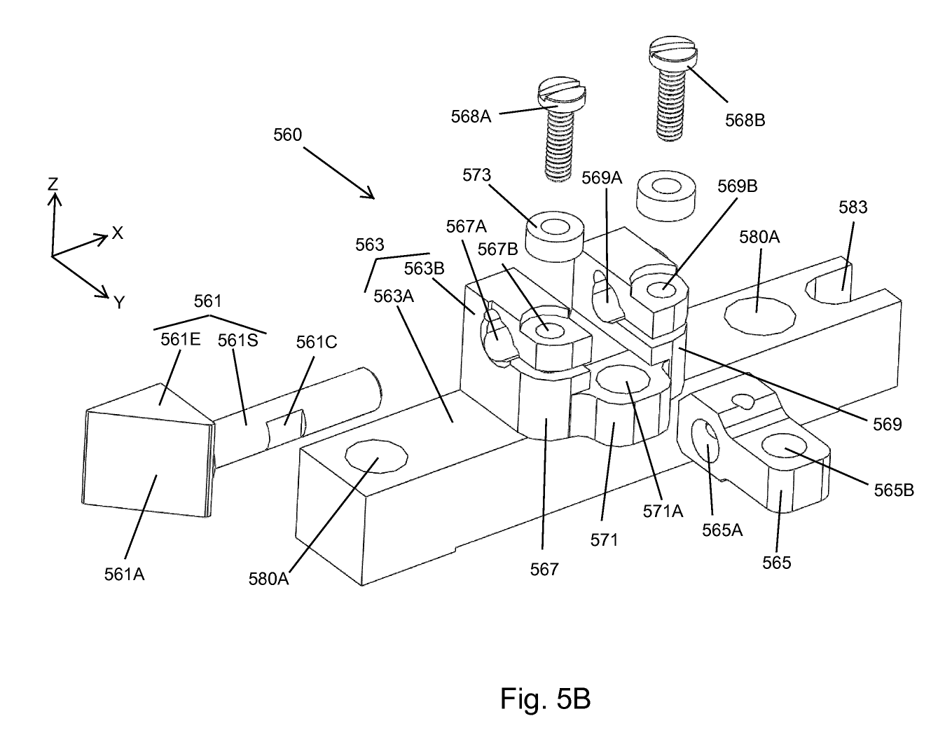

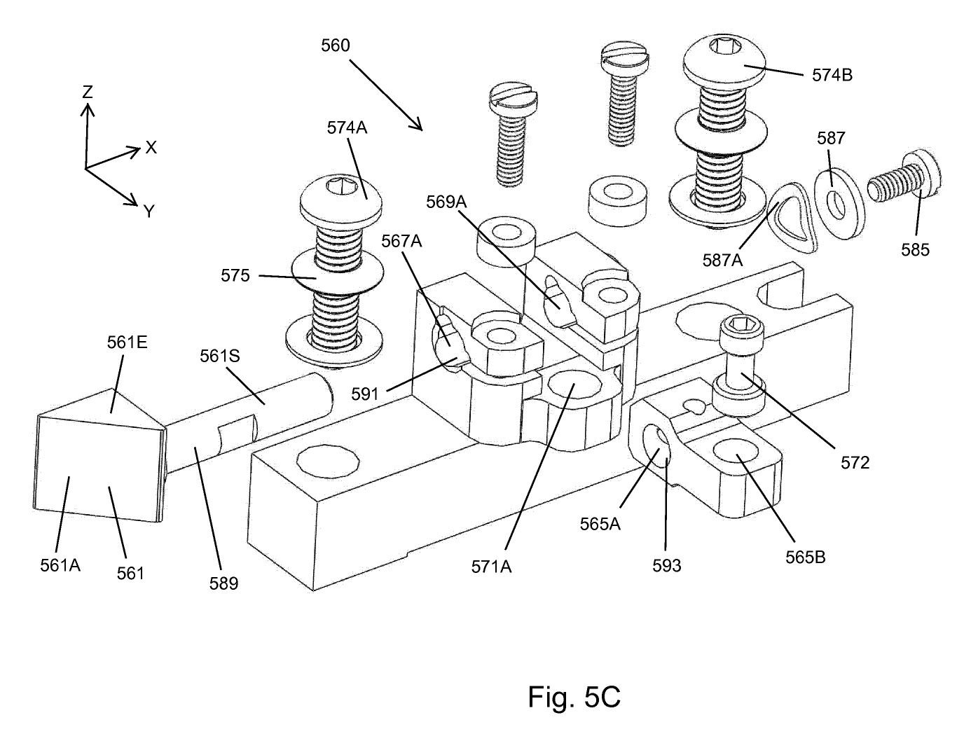

FIG. 5A is a perspective view of another embodiment of a mirror mount 560 having features of the present invention. The mirror mount 560, as illustrated in FIG. 5A, provides many if not all of the same stability features for the laser system 228 (illustrated in FIG. 2A) as were discussed in relation to the mirror mount 460 illustrated and described in relation to FIGS. 4A-4F. Additionally, in this embodiment, the mirror mount 560 is again a two-axis mirror mount 560 that has exceptional (<50-100 urad) long term pointing stability, that is stable over extreme temperature soaks (−55 to 85 C), and that is stable over shock and vibration. More particularly, in certain embodiments, the mirror mount 560 can be designed to provide tip (rotation about the X axis) and tilt (rotation about the Z axis) adjustments to enable the mirror mount 560 to precisely steer the MIR beams 356 (illustrated in FIG. 3A) and/or the non-MIR beam 358 (illustrated in FIG. 3A) toward the combiner lens 364 (illustrated in FIG. 3A).

As with the previous embodiment, the mirror mount 560 can be secured to the mounting base 226 (illustrated in FIG. 2A). The design of the mirror mount 560 can be varied to suit the specific requirements of the laser system 228. In this embodiment, the mirror mount 560 includes a mirror shaft 561 having a reflective surface 561A, a director base 563 (also referred to herein as a “base”) and a tip lever 565 that are adjustably coupled together so as to enable precise tip and tilt adjustments of the mirror shaft 561 and the reflective surface 561A relative to the mounting base 226. In one embodiment, the reflective surface 561A is a polished, gold-plated surface formed on an aluminum mirror shaft 561. The reflective surface 561A reflects the MIR beams 356 and/or the non-MIR beams 358 toward the combiner lens 364. Additionally, in this embodiment, the reflective surface 561A is integral to the mirror shaft 561. Thus, there is no glue and no mechanical joints that connect the reflective surface 561A to the rest of the mirror shaft 561, which enables the mirror mount 560 to exhibit improved stability during use.

It should be noted that the mirror shaft 561 can be referred to generically as a reflective element and the tip lever 565 can be referred to generically as a rotation adjustment element.

In one embodiment, the mirror shaft 561, the base 563 and the mounting base 226 can all be made of the same or very similar material. For example, in one embodiment, each of the mirror shaft 561, the base 563 and the mounting base 226 can be made of an aluminum material. As a result thereof, there is no or very little CTE mismatch, which enables the mirror mount 560 to exhibit improved stability during use.

In the embodiment illustrated in FIG. 5A, precise tip adjustment of the mirror mount 560 can be accomplished through the use of a first element fastener 568A, a second element fastener 568B, the mirror shaft 561, and an adjuster 572. As illustrated herein, in on embodiment, each element fastener 568A, 568B can be a locking screw. Alternatively, the element fasteners 568A, 568B can have a different design. Still alternatively, in one embodiment, the mirror mount 560 can be designed to include only one element fastener.

Each of the first element fastener 568A and the second element fastener 568B can be threaded into the base 563 to selectively fix the position of the mirror shaft 561 relative to the base 563. In particular, each of the first element fastener 568A and the second element fastener 568B are selectively movable between a locked position and an unlocked position to selectively inhibit rotation of the mirror shaft 561 relative to the base 563 about the X axis. Further, each of the first element fastener 568A and the second element fastener 568B move along an axis that is orthogonal to the X axis during movement between the unlocked position and the locked position.

Additionally, the mirror shaft 561 rotates relative to the base 563 for tip adjustment of the reflective surface 561A relative to the base 563. Stated another way, a portion of the base 563 provides a rotation axis guide for tip adjustment of the reflective surface 561A relative to the base 563. With this design, the element fasteners 568A, 568B can be loosened to allow the reflective surface 561A to be rotated, i.e. by rotating the mirror shaft 561 (about the X axis) relative to the base 563, and subsequently tightened, i.e. moved from the unlocked position to the locked position, to fixedly secure the mirror shaft 561 and the reflective surface 561A relative to the base 563. Further, the adjuster 572 extends into and through the tip lever 565 so that the adjuster 572 can engage the base 563, and, thus, be used to rotate the tip lever 565 and the mirror shaft 561 relative to the base 563. Tip adjustment will be described in greater detail below.

Somewhat similar to the mirror mount 460 illustrated in FIG. 4A, tilt actuation in one non-exclusive embodiment of the mirror mount 560 illustrated in FIG. 5A can be done via an eccentric tilt adjustment tool (not illustrated), which operates in a groove 583 in the base 563. More particularly, the eccentric tool has a circular tip that fits into a circular aperture (not shown) in the mounting base 226 and an eccentric section, e.g., an oval section, that fits into the groove 583. Additionally, in this embodiment, precise tilt adjustment of the mirror mount 560 can be accomplished through the use of a base pivot 574A and a base fastener 574B (also referred to herein as a “fastener”), and the eccentric tool. In one embodiment, the base pivot 574A can be fixedly secured to, i.e. threaded into, the mounting base 226, and the base fastener 574B can be a locking screw that is selectively threaded into the mounting base 226. Alternatively, one or both of the base pivot 574A and the base fastener 574B can have a different design. As shown in FIG. 5A, the base pivot 574A extends through the base 563 and the base fastener 574B extends through the base 563 to secure the mirror mount 560 to the mounting base 226.

As shown in FIG. 5A, each of the base pivot 574A and the base fastener 574B extend through the base 563 to selectively secure the mirror mount 560 to the mounting base 226 and/or to selectively inhibit rotation of the base 563 relative to the mounting base 226. In particular, each of the base pivot 574A and the base fastener 574B are selectively movable between a locked position and an unlocked position to selectively inhibit rotation of the base 464 relative to the mounting base 226 about the Z axis. Further, each of the base pivot 474A and the base fastener 474B move along an axis that is orthogonal to the Z axis during movement between the unlocked position and the locked position.

In this embodiment, the tool has an eccentric region that engages the groove 583. With this design, when the base fastener 574B is loosened, i.e. is moved from the locked position to the unlocked position, the tool can be rotated within the groove 583 to tilt the base 563 relative to the mounting base 226. Subsequently, the base fastener 574B can be tightened, i.e. moved from the unlocked position to the locked position, to secure the base 563 to the mounting base 226. Moreover, the base pivot 574A acts as a shoulder bolt that provides a rotational axis guide for tilt adjustment about the Z axis.

FIG. 5B is an exploded perspective view of a portion of the mirror mount 560 illustrated in FIG. 5A. More particularly, FIG. 5B more clearly illustrates the structure of and at least some of the connections between the mirror shaft 561, the tip lever 565 and the base 563.

In this embodiment, the mirror shaft 561 includes a substantially triangle shaped end section 561E that includes the reflective surface 561A, and a shaft portion 561S having a substantially circular cross-section that cantilevers away from the end section 561E. The shaft portion 561S further includes a pair of flat, cutout sections 561C (only one is illustrated in FIG. 5B) positioned on opposite sides of the shaft portion 561S. Additionally, the tip lever 565 can include a threaded set screw (not illustrated) that can be urged against one of the cutout sections 561C to inhibit rotation between the tip lever 565 and the shaft portion 561S of the mirror shaft 561. Alternatively, an adhesive can be used to inhibit relative rotation between the tip lever 565 and the shaft portion 561S of the mirror shaft 561.

Additionally, in this embodiment, the tip lever 565 includes a lever shaft aperture 565A that is sized and shaped to receive the shaft portion 561S of the mirror shaft 561, and an internally threaded lever adjustment aperture 565B that receives the adjuster 572 (illustrated in FIG. 5A).

Further, as shown in FIG. 5B, the base 563 includes a lower section 563A and an upper section 563B. The lower section 563A of the base 563 is substantially rectangular bar shaped and includes a pair of tilt base apertures 580A for receiving the tilt pivot 574A (illustrated in FIG. 5A) and the base fastener 574B (illustrated in FIG. 5A), respectively, and the groove 583 that receives the eccentric tool (not illustrated) during tilt adjustment.

The upper section 563B of the base 563 is somewhat U-shaped and includes (i) a first side 567 having a first shaft aperture 567A and a first tip base aperture 567B; (ii) a spaced apart second side 569 having a second shaft aperture 569A and a second tip base aperture 569B; and (iii) a middle section 571 having a base adjustment aperture 571A, the middle section 571 being positioned substantially between and adjacent to (or integral with) the first side 567 and the second side 569.

During use, the tip lever 565 is positioned between the first side 567 and the second side 569 of the base 563 such that the lever shaft aperture 565A is aligned with the first shaft aperture 567A and the second shaft aperture 569A of the base 563. With this design, the shaft portion 561S of the mirror shaft 561 can extend into and/or through the first shaft aperture 567A, the lever shaft aperture 565A and the second shaft aperture 569A. Moreover, the first shaft aperture 567A and the second shaft aperture 569A provide the rotation axis guide for tip adjustment of the reflective surface 561A relative to the base 563. It should be noted that, based on this function, the first shaft aperture 567A and/or the second shaft aperture 569A can also be referred to as an element pivot.

Further, in one embodiment, the size and diameter of the first shaft aperture 567A and the second shaft aperture 569A can be selectively adjusted. For example, when the element fasteners 568A, 568B are loosened, i.e. are moved from locked position to unlocked position, the first shaft aperture 567A and the second shaft aperture 569A will have a size and diameter that allows the shaft portion 561S of the mirror shaft 561 to rotate relative to the base 563. Subsequently, when the element fasteners 568A, 568B are tightened, i.e. are moved from unlocked position to locked position, the diameter of the first shaft aperture 567A and the second shaft aperture 569A decreases such that the first shaft aperture 567A and the second shaft aperture 569A effectively clamp down on the shaft portion 561S of the mirror shaft 561 to inhibit relative rotation between the mirror shaft 561 and the base 563.

Additionally, during use, the lever adjustment aperture 565B is aligned with the base adjustment aperture 571A such that the adjuster 572 (illustrated in FIG. 5A) can be threaded through the lever adjustment aperture 565A and into the base adjustment aperture 571A. In one embodiment, the adjuster 572 can be a set screw that is threaded into the lever adjustment aperture 565B and that contacts a pad (not illustrated), e.g., a sapphire pad, positioned at the base of the base adjustment aperture 571A. With this design, as the adjuster 572 is rotated, the adjuster 572 will be threading one way or the other through the lever adjustment aperture 565A (depending on the direction of rotation of the adjuster 572) such that the tip lever 565 will rotate about the X axis relative to the base 563. Moreover, with the shaft portion 561S of the mirror shaft 561 being secured within the lever shaft aperture 565A, the rotation of the tip lever 565 will result in a corresponding rotation of the mirror shaft 561 relative to the base 563. In one non-exclusive, alternative embodiment, the adjuster 572 can be designed as a differential screw, and each of the lever adjustment aperture 565B and the base adjustment aperture 571A will be threaded, albeit with different thread pitches. In such embodiment, due to the varying thread pitches, the adjuster 572 will move translationally at different rates within the lever adjustment aperture 565B and within the base adjustment aperture 571A during rotation of the adjuster 572. Stated another way, due to the varying thread pitches, rotation of the adjuster 572 in one direction results in the tip lever 565, i.e. the lever adjustment aperture 565B, and the base 563, i.e. the base adjustment aperture 571A, moving closer together, and rotation of the adjuster 572 in the other direction results in the tip lever 565, i.e. the lever adjustment aperture 565B, and the base 563, i.e. the base adjustment aperture 571A, moving farther apart. Accordingly, in such embodiment, the different translational movement rates will result in the tip lever 565 rotating relative to the base 563.

Further, as illustrated in FIG. 5B, a spacer 573 can be positioned adjacent to each of the first tip base aperture 567B and the second tip base aperture 569B such that the element fasteners 568A, 568B extend through the respective spacer 573 prior to threading into the corresponding tip base aperture 567B, 569B. In certain embodiments, the spacers 573 can be made of a certain size and of a certain material so as to compensate for any CTE mismatch between the element fasteners 568A, 568B and the base 563. For example, if the coefficient of thermal expansion of the element fastener 568A, 568B is less than the coefficient of thermal expansion of the base 563, this can be compensated for by (i) making the fastener 568A, 568B longer with the use of the spacers 573 to compensate for the CTE mismatch, and/or (ii) using a spacer 573 with an appropriate coefficient of thermal expansion to compensate for the CTE mismatch between the fastener 568A, 568B and the base 563.

Thus, the mirror mount 560 is able to exhibit improved stability during use.

FIG. 5C is an exploded perspective view of the mirror mount 560 illustrated in FIG. 5A. More particularly, more clearly illustrates the structure of and the connections between the mirror shaft 561, the tip lever 565 and the base 563. Moreover, FIG. 5C includes certain features of the mirror mount 560 that were omitted from FIG. 5B for purposes of clarity. For example, in addition to the features illustrated in FIG. 5B, FIG. 5C illustrates that one or more washers 575, e.g., preload washers, can be positioned about the base pivot 574A and the base fastener 574B.

Additionally, FIG. 5C illustrates that the mirror shaft 561 can be further secured or clamped within the first shaft aperture 567A, the lever shaft aperture 565A and the second shaft aperture 569A with a shaft screw 585 and one or more washers 587, including a resilient member 587A, e.g., a spring washer, that can be positioned adjacent to the second shaft aperture 569A. In one embodiment, the shaft screw 585 can be threaded into the end of the shaft portion 561S of the mirror shaft 561 away from the end portion 561E. With this design, when the shaft screw 585 is tightened into the end of the shaft portion 561S of the mirror shaft 561, the end portion 561E of the mirror shaft 561 is urged against the first side 567 of the base 563. Further, the inclusion of the resilient member 587A enables the mirror shaft 561 to be rotated about the X axis relative to the base 563 when the element fasteners 568A, 568B are loosened, while still urging the end portion 561E of the mirror shaft 561 against the first side 567 of the base 563 to maintain the precise position of the reflective surface 561A along the X axis during the adjustment procedure.

Further, FIG. 5C illustrates the adjuster 572 that extends into the lever adjustment aperture 565B and the base adjustment aperture 571A. In one embodiment, as discussed in detail above, the lever adjustment aperture 565B can be a through hole and the adjuster 572 can extend through the lever adjustment aperture 565B and into the base adjustment aperture 571A. Alternatively, the base adjustment aperture 571A can be a through hole and the adjuster 572 can extend through the base adjustment aperture 571A and into the lever adjustment aperture 565B. Still alternatively, the adjuster 572 can extend through both the lever adjustment aperture 565B and the base adjustment aperture 571. Further, in alternative embodiments, one or both of the lever adjustment aperture 565B and the base adjustment aperture 571A can be internally threaded. Still alternatively, tip adjustment can be achieved in a different manner.

As shown in FIG. 5C, the mirror shaft 561 includes a tip interface surface 589 (i.e. the outer surface of the shaft portion 561S of the mirror shaft 561) that interfaces with a base tip interface surface 591 (i.e. the interior surface of the first shaft aperture 567A and the interior surface of the second shaft aperture 569A) and a lever tip interface surface 593 (i.e. the interior surface of the lever shaft aperture 565A). The tip adjustment occurs at a sliding and locking tip interface between the mirror shaft 561 and the base 563 (i.e. between the shaft tip interface surface 589 and the base tip interface surface 591) and between the mirror shaft 561 and the tip lever 565 (i.e. between the shaft tip interface surface 589 and the lever tip interface surface 591). Moreover, as illustrated, the tip interface (positioned in the Y-Z plane) is orthogonal to the axis of rotation (about the X axis) during tip adjustment. With this design, the mirror mount 560 is able to exhibit improved stability during use.

Additionally, tilt adjustment occurs at a sliding and locking tilt interface between the base 563 and the mounting base 226 (illustrated in FIG. 2A), i.e. between the bottom surface of the lower section 563A of the base 563 and the upper surface of the mounting base 226. Moreover, the tilt interface (positioned in the X-Y plane) is orthogonal to axes of rotation (about the Z axis) during tilt adjustment. Again, with this design, the mirror mount 560 is able to exhibit improved stability during use.

Additionally, (i) the element fasteners 568A, 568B that lock the tip interface (e.g., that secure the mirror shaft 561 to the base 563 and to the tip lever 565) are oriented and/or move along an axis that is orthogonal to the tip interface plane, and (ii) the base pivot 574A and the base fastener 574B that lock the tilt interface (e.g., that secure the base 563 to the mounting base 226) are oriented and/or move along an axis that is orthogonal to the tilt interface plane. Further, any CTE mismatch of the fasteners 568A, 568B, 574B and the base pivot 574A is out-of-plane and therefore does not affect long-term stability.

It should be noted that the mirror mount 560 illustrated in FIGS. 5A-5C can be designed with fewer components than that illustrated in these Figures. For example, the tip lever 565 can be eliminated. In this design, during adjustment, a wrench (not show) can be used to engage the flats 561C on the shaft 561S to selectively rotate the shaft 561S.

One skilled in the art can easily recognize that the features of the mirror mounts 460, 560 illustrated and described herein in relation to FIGS. 4A-4F and 5A-5C can be utilized in mechanisms other than mirror mounts. In particular, one skilled in the art can expand the use of the orthogonal interface clamping scheme, as described in detail above, to adjust mechanisms such as periscope mounts, filter mounts, or other devices whose optical surface is not integral to the mirror plate or mirror shaft.

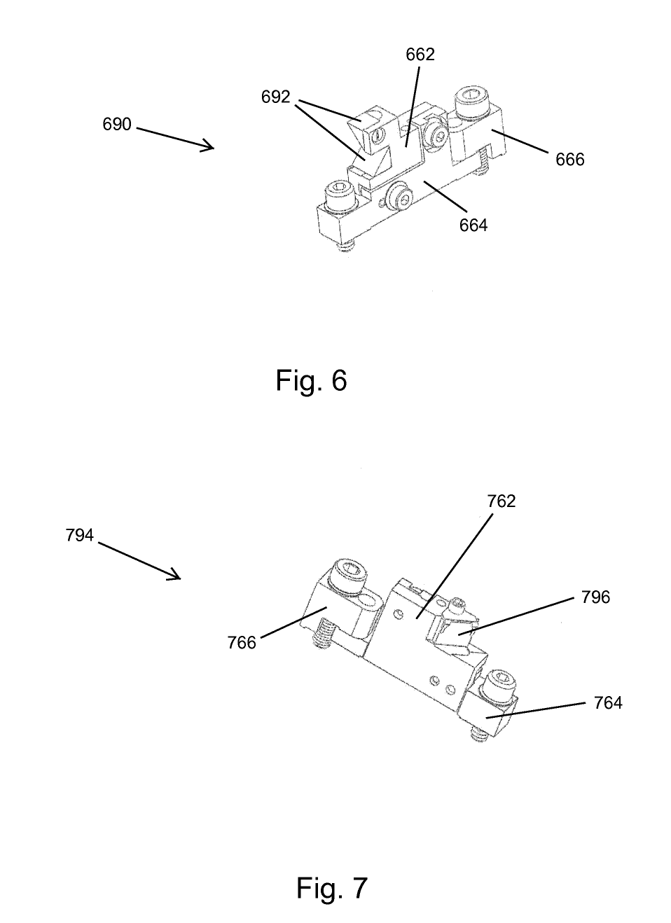

For example, FIG. 6 is a perspective view of an embodiment of a periscope mount 690 having features of the present invention. More particularly, the periscope mount 690 includes a plate 662, a director base 664, and a tilt clamp 666 that are substantially similar to the mirror plate 462, the director base 464, and the tilt clamp 466 illustrated and described in detail above in relation to FIG. 4A-4F. However, instead of including a plate reflective surface that is integral to the mirror plate, the periscope mount 690 includes a pair of bolted on mirrors 692. It should be noted that the mirrors 692 can also be referred to as reflective elements or reflective surfaces.

Additionally, FIG. 7 is a perspective view of an embodiment of a filter mount 794 having features of the present invention. More particularly, the filter mount 794 includes a plate 762, a director base 764, and a tilt clamp 766 that are substantially similar to the mirror plate 462, the director base 464, and the tilt clamp 466 illustrated and described in detail above in relation to FIG. 4A-4F. However, instead of including a plate reflective surface that is integral to the mirror plate, the filter mount 794 includes a mechanically clamped dichroic filter 796. Additionally, the dichroic filter 796 transmits beams having a center wavelength within a certain range, and the dichroic filter 796 reflects beams having a center wavelength outside of that certain range. As the dichroic filter 796 reflects beams of a certain center wavelength, the dichroic filter 796 can also be referred to as a reflective element or a reflective surface.

While a number of exemplary aspects and embodiments of a mirror mount 460, 560 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A beam director for directing a beam, the beam director being secured to a mounting base, the beam director comprising:
a director base positioned adjacent to the mounting base, wherein a first interface between the director base and the mounting base is in a first interface plane that is orthogonal to a first axis;
a reflective element having a reflective surface;
a base pivot that provides a base pivot axis for selectively rotating the director base and the reflective element relative to the mounting base about the first axis;
an element pivot that guides the rotation of the reflective element relative to the director base about a second axis that is orthogonal to the first axis; and
a first element fastener that is selectively movable between a locked position and an unlocked position to selectively inhibit rotation of the reflective element relative to the director base about the second axis, the first element fastener moving along an axis that is orthogonal to the second axis during movement between the unlocked position and the locked position.

2. The beam director of claim 1 wherein the reflective surface is integral to the reflective element.

3. The beam director of claim 1 wherein the director base, the reflective element and the mounting base are each made of the same material.

4. The beam director of claim 1 further comprising an adjuster that selectively adjusts the position of the reflective element relative to the director base about the second axis.

5. The beam director of claim 4 wherein the adjuster is threaded into and through the reflective element so that a distal tip of the adjuster selectively engages the director base.

6. The beam director of claim 1 wherein the reflective element is positioned adjacent to the director base, and wherein a second interface between the reflective element and the director base is in a second interface plane that is orthogonal to the second axis.

7. The beam director of claim 1 further comprising a base fastener that selectively clamps the director base to inhibit rotation of the director base and the reflective element relative to the mounting base about the first axis.

8. The beam director of claim 1 wherein the first element fastener extends through the director base and is threaded into the reflective element.

9. The beam director of claim 1 wherein the first element fastener is threaded into the director base.

10. The beam director of claim 1 further comprising a second element fastener that is selectively movable between a locked position and an unlocked position to selectively inhibit rotation of the reflective element relative to the director base about the second axis, the second element fastener moving along an axis that is orthogonal to the second axis during movement between the unlocked position and the locked position.

11. The beam director of claim 1 wherein the reflective element includes an element end having the reflective surface and an element shaft that cantilevers away from the element end.

12. The beam director of claim 11 wherein the director base includes a shaft aperture that receives the element shaft, the shaft aperture allowing the element shaft to selectively rotate relative to the director base.

13. The beam director of claim 12 wherein the first element fastener selectively adjusts a size of the shaft aperture to selectively inhibit rotation of the element shaft within the shaft aperture.

14. The beam director of claim 1 further comprising (i) a base fastener that selectively clamps the director base to inhibit rotation of the director base and the reflective element relative to the mounting base about the first axis; (ii) a second element fastener that is selectively movable between a locked position and an unlocked position to selectively inhibit rotation of the reflective element relative to the director base about the second axis, the second element fastener moving along an axis that is orthogonal to the second axis during movement between the unlocked position and the locked position, the first element fastener and the second element fastener extending through the director base and being threaded into the reflective element; and (iii) an adjuster that selectively adjusts the position of the reflective element relative to the director base about the second axis; and wherein the reflective element is positioned adjacent to the director base, wherein a second interface between the reflective element and the director base is in a second interface plane that is orthogonal to the second axis, and wherein the reflective surface is integral to the reflective element.

15. The beam director of claim 1 further comprising (i) a base fastener that selectively clamps the director base to inhibit rotation of the director base and the reflective element relative to the mounting base about the first axis; and (ii) an adjuster that selectively adjusts the position of the reflective element relative to the director base about the second axis; and wherein the first element fastener is threaded into the director base; wherein the reflective element includes an element end having the reflective surface and an element shaft that cantilevers away from the element end; wherein the director base includes a shaft aperture that receives the element shaft, the shaft aperture allowing the element shaft to selectively rotate relative to the director base; wherein the first element fastener selectively adjusts a size of the shaft aperture to selectively inhibit rotation of the element shaft within the shaft aperture; wherein a resilient member is positioned adjacent to the shaft aperture, the resilient member urging the element end against the director base; and wherein the reflective surface is integral to the reflective element.

16. A laser system including a laser source that generates a beam, and the beam director of claim 1 that directs the beam.

17. A laser source assembly including a mounting base, the laser system of claim 16 that is secured to the mounting base, and a thermal module that controls the temperature of the mounting base and the laser system.

18. A method for directing a beam, the method comprising the steps of:
positioning a director base adjacent to a mounting base such that a first interface between the director base and the mounting base is in a first interface plane that is orthogonal to a first axis;
coupling a reflective element to the director base, the reflective element having a reflective surface;
selectively rotating the director base and the reflective element relative to the mounting base about the first axis;
selectively rotating the reflective element relative to the director base about a second axis that is orthogonal to the first axis; and
selectively inhibiting rotation of the reflective element relative to the director base about the second axis with a first element fastener, the first element fastener being selectively movable between a locked position and an unlocked position, the first element fastener moving along an axis that is orthogonal to the second axis during movement between the unlocked position and the locked position.

19. The method of claim 18 further comprising the step of selectively inhibiting rotation of the reflective element relative to the director base about the second axis with a second element fastener, the second element fastener being selectively movable between a locked position and an unlocked position, the second element fastener moving along an axis that is orthogonal to the second axis during movement between the unlocked position and the locked position.

20. The method of claim 18 further comprising the step of selectively clamping the director base with a base fastener to inhibit rotation of the director base and the reflective element relative to the mounting base about the first axis.

21. The method of claim 18 further comprising the step of selectively adjusting the position of the reflective element relative to the director base about the second axis with an adjuster.

22. The method of claim 18 wherein the step of coupling includes the reflective surface being integral to the reflective element.

23. The method of claim 18 wherein the step of coupling includes the step of positioning the reflective element adjacent to the director base such that a second interface between the reflective element and the director base is in a second interface plane that is orthogonal to the second axis.

24. The method of claim 18 wherein the step of coupling includes the reflective element including an element end having the reflective surface and an element shaft that cantilevers away from the element end.

25. The method of claim 24 wherein the step of positioning includes the director base having a shaft aperture that receives the element shaft, the shaft aperture allowing the element shaft to selectively rotate relative to the director base; and further comprising the step of selectively adjusting a size of the shaft aperture with the first element fastener to selectively inhibit rotation of the element shaft within the shaft aperture.
